(19) United States
(12) Patent Application Publication
(10) Pub. No.: US 2026/0100645 A1
(43) Pub. Date: Apr. 9, 2026

(54) HYBRID SWITCHING CONVERTER WITH SINGLE INDUCTOR AND MULTIPLE OUTPUTS AND CONTROL METHOD THEREOF

(71) Applicant: Richtek Technology Corporation, Zhubei City (TW)

(72) Inventors: Kuo-Chi Liu, Hsinchu (TW); Chih-Hua Hou, Hsinchu (TW)

(21) Appl. No.: 19/185,844

(22) Filed: Apr. 22, 2025

Related U.S. Application Data
(60) Provisional application No. 63/704,077, filed on Oct. 7, 2024.

(30) Foreign Application Priority Data
Feb. 19, 2025 (TW) 114106048

(51) Int. Cl. H02M 3/07; H02M 1/00; H02M 3/157; H02M 3/158

(52) U.S. Cl. CPC H02M 3/07; H02M 1/0009; H02M 1/0025; H02M 1/009; H02M 3/157; H02M 3/1582

(57) ABSTRACT

The present invention discloses a hybrid switching converter with a single inductor and multiple outputs and a control method thereof, configured to convert an input voltage to a first and a second output voltages. The hybrid switching converter includes: a sub-switching converter, which converts the input voltage to an intermediate voltage; a first and a second output switches, which conduct the intermediate voltage during a first and a second inductance periods, respectively, to generate the first and second output voltages. The sub-switching converter comprises: a switched capacitor voltage divider circuit, which controls multiple switches through pulse-width modulation (PWM) signals to generate two divided voltage levels in each inductance cycle for supplying an inductor therein; and a control circuit, which generates PWM signals to control the multiple switches and the output switches in a time-division manner, and regulates the output voltages to target values according to output voltage feedback signals.

### CROSS REFERENCE

The present invention claims priority to provisional application 63/704,077 filed on Oct. 7, 2024, and TW 114106048 filed on Feb. 19, 2025.

### BACKGROUND OF THE INVENTION

### Field of Invention

The present invention relates to a hybrid switching converter with a single inductor and multiple outputs and a control method thereof, and more particularly to a hybrid switching converter capable of generating multiple output voltages using a single inductor and a corresponding control method.

### Description of Related Art

Today's data centers, servers, electric vehicles, and various mobile devices frequently require power converters with multiple output voltages. Under increasingly stringent requirements for limited installation space and harsh thermal environments, designing power converters with high power density and high efficiency has become a crucial research topic. Conventionally, this is typically addressed using multiple power converter architectures, each equipped with separate inductors and switches to support different outputs.

In prior art, as shown in FIG. 1, a switching converter 10 with multiple outputs provides multiple sets of outputs through different combinations of switches and inductors. In FIG. 1, an input voltage Vin is simultaneously coupled to two buck converters, wherein switches Q1, Q2 and an inductor L1 form a first buck converter, and switches Q3, Q4 and an inductor L2 form a second buck converter, corresponding respectively to a first output voltage Vout1 and a second output voltage Vout2. At the input side, an input capacitor Cin1 is coupled to an input of the first buck converter, and an input capacitor Cin2 is coupled to an input of the second buck converter to filter input-side voltage ripples. At an output side, an output capacitor Co1 is coupled to an output of the first buck converter to stabilize its output voltage, and an output capacitor Co3 is coupled to an output of the second buck converter to stabilize its output voltage. Meanwhile, an output capacitor Co2 is coupled to the first output voltage Vout1, and an output capacitor Co4 is coupled to the second output voltage Vout2 to further reduce output noise and stabilize the respective output voltages. Notably, an output switch Q5 is coupled between the first buck converter and the first output voltage Vout1 to convert the output voltage of the first buck converter to the first output voltage Vout1, and output switch Q6 is coupled between the second buck converter and the second output voltage Vout2 to convert the output voltage of the second buck converter to the second output voltage Vout2.

In the multi-output switching converter 10 shown in FIG. 1, the switches Q1-Q4 in each buck converter must withstand the maximum value of input voltage Vin to ensure stable operation. As the input voltage Vin may be significantly high, the voltage rating requirements for switches Q1-Q4 consequently increase, resulting in higher internal conduction resistance and conduction losses. Additionally, conventional buck converters require larger inductors L1, L2 to handle the voltage difference between the input voltage Vin and the output voltages Vout1 and Vout2 during high-voltage energy conversion. This leads to increased size and cost of inductors L1, L2, making it challenging to further reduce the overall power supply size or improve power density.

Since each output requires an independent buck converter and inductor, the system layout and thermal management become increasingly challenging. Under high-temperature conditions or constrained thermal environments, additional heat dissipation measures or higher specification components are required to ensure stability and long-term reliability, further increasing the system's cost and complexity.

In multi-output voltage applications, conventional approaches repetitively use multiple power converters. If a system needs to simultaneously support multiple output voltages (such as USB ports, system core voltage, peripheral supply voltage, etc.), the number of components and wiring complexity significantly increase, making integration into a single monolithic chip or module difficult.

In view of the above, to address these issues and simultaneously achieve goals of high density, high efficiency, and ease of integration, the present invention provides a hybrid switching converter with a single inductor and multiple outputs and a corresponding control method. This invention substantially reduces voltage stress on switching elements and inductor requirements while maintaining stable outputs and high efficiency, thereby enhancing system integration and reliability.

### SUMMARY OF THE INVENTION

From one perspective, the present invention provides a hybrid switching converter with a single inductor and multiple outputs, wherein the hybrid switching converter is configured to convert an input voltage to a first output voltage and a second output voltage. The hybrid switching converter includes: a sub-switching converter that converts the input voltage to an intermediate voltage; a first output switch configured to turn ON during a first inductance period to convert the intermediate voltage to the first output voltage based on a first time-division signal; and a second output switch configured to turn ON during a second inductance period to convert the intermediate voltage to the second output voltage based on a second time-division signal; wherein the sub-switching converter comprises: a switched capacitor voltage divider circuit configured to perform a switched-capacitor operation to convert a first voltage to a first set of divided voltages with two different voltage levels by controlling a plurality of switches during the first inductance period based on a first set of pulse-width modulation (PWM) signals, and perform a switched-capacitor operation to convert the first voltage to a second set of divided voltages with two different voltage levels by controlling the plurality of switches during the second inductance period based on a second set of PWM signals; an inductor having a first terminal coupled to the switched capacitor voltage divider circuit and a second terminal coupled to a second voltage; wherein, during the first inductance period, the first terminal of the inductor is switched between the two voltage levels of the first set of divided voltages based on the first set of PWM signals; wherein, during the second inductance period, the first terminal of the inductor is switched between the two voltage levels of the second set of divided voltages based on the second set of PWM signals; and a control circuit configured to generate the first set of PWM signals, the second set of PWM signals, the first time-division signal, and the second time-division signal, to time-divisionally control the plurality of switches, the first output switch, and the second output switch, such that the same inductor is periodically magnetized and demagnetized during the first and second inductance periods to perform power conversion between the first voltage and the second voltage, and to correspondingly generate the first output voltage and the second output voltage during the first and second inductance periods, respectively; wherein the first voltage and the second voltage respectively correspond to one of the input voltage and the intermediate voltage; wherein the control circuit is further configured to regulate the first output voltage to a first target voltage based on a first feedback signal related to the first output voltage during the first inductance period, and regulate the second output voltage to a second target voltage based on a second feedback signal related to the second output voltage during the second inductance period; wherein the hybrid switching converter with a single inductor and multiple outputs operates in a boundary conduction mode (BCM) or a discontinuous conduction mode (DCM) during the first and second inductance periods.

From another perspective, the present invention provides a control method for a hybrid switching converter with a single inductor and multiple outputs. The control method includes: converting an input voltage to an intermediate voltage; turning ON a first output switch during a first inductance period to output the intermediate voltage as a first output voltage based on a first time-division signal; and turning ON a second output switch during a second inductance period to output the intermediate voltage as a second output voltage based on a second time-division signal; wherein the step of converting the input voltage to the intermediate voltage includes: during the first inductance period, controlling a plurality of switches based on a first set of pulse-width modulation (PWM) signals to perform a switched-capacitor operation and convert a first voltage to a first set of divided voltages with two different voltage levels; and during the second inductance period, controlling the plurality of switches based on a second set of PWM signals to perform a switched-capacitor operation and convert the first voltage to a second set of divided voltages with two different voltage levels; switching a first terminal of an inductor between the two voltage levels of the first set of divided voltages based on the first set of PWM signals during the first inductance period; switching the first terminal of the inductor between the two voltage levels of the second set of divided voltages based on the second set of PWM signals during the second inductance period; time-divisionally controlling the plurality of switches using the first set of PWM signal and the second set of PWM signal, such that the same inductor is periodically magnetized and demagnetized during the first inductance period and the second inductance period to perform power conversion between the first voltage and the second voltage; wherein the first voltage and the second voltage respectively correspond to one of the input voltage and the intermediate voltage; time-divisionally controlling the first output switch and the second output switch using the first time-division signal and the second time-division signal to correspondingly generate the first output voltage and the second output voltage during the first inductance period and the second inductance period; and adjusting the first output voltage to a first target voltage based on a first feedback signal related to the first output voltage during the first inductance period, and adjusting the second output voltage to a second target voltage based on a second feedback signal related to the second output voltage during the second inductance period; wherein the hybrid switching converter with a single inductor and multiple outputs operates in a boundary conduction mode (BCM) or a discontinuous conduction mode (DCM) during the first and second inductance periods.

In one embodiment, any two consecutive first inductance periods achieve a capacitor balancing state, and any two consecutive second inductance periods also achieve a capacitor balancing state.

In one embodiment, the control circuit includes: a first error amplifier configured to amplify a difference between a first output voltage feedback signal and a first reference signal to generate a first error amplification signal; a second error amplifier configured to amplify a difference between a second output voltage feedback signal and a second reference signal to generate a second error amplification signal; and a modulation circuit configured to generate the first set of PWM signals based on the first error amplification signal during the first inductance period, and to generate the second set of PWM signals based on the second error amplification signal during the second inductance period.

In one embodiment, the control circuit further includes a current sensing circuit configured to sense an inductor current flowing through the inductor and generate an inductor current signal, and the modulation circuit further generates the first and second sets of PWM signals based on the inductor current signal.

In one embodiment, the current sensing circuit generates a zero current signal when the inductor current reaches zero current. The control circuit further includes a logic circuit configured to generate the first and second time-division signals based on the zero current signal.

In one embodiment, the control circuit further includes a logic circuit configured to generate the first and second time-division signals based on a clock signal.

In one embodiment, the control circuit further includes a logic circuit configured to generate a time-division switching control signal, the first time-division signal, and the second time-division signal based on the first error amplification signal, the second error amplification signal, and a clock signal or a zero current signal. The time-division switching control signal, the first time-division signal, and the second time-division signal are triggered by the clock signal or the zero current signal, and the first time-division signal and the second time-division signal are inverted relative to each other. The logic circuit further determines whether the hybrid switching converter with a single inductor and multiple outputs enters a skip mode based on a difference between a first output current and a second output current. In the skip mode, the difference between the number of first inductance periods and the number of second inductance periods within a unit cycle is positively correlated with the difference between the first output current and the second output current.

In one embodiment, the current sensing circuit includes a sensing resistor and a sensing capacitor, wherein the sensing resistor and the sensing capacitor are connected in series and coupled to the inductor. An inductor current signal is generated by sensing the voltage across the sensing capacitor, wherein a time constant of the sensing resistor and the sensing capacitor is matched to a time constant of the inductor and a DC resistance of the inductor.

In one embodiment, the power conversion between the first voltage and the second voltage is either a boost conversion or a buck conversion.

In one embodiment, when the switched capacitor voltage divider circuit and the inductor are configured in a buck topology, the sub-switching converter further includes a boost switch coupled between the second terminal of the inductor and a reference potential, such that the hybrid switching converter with a single inductor and multiple outputs selectively operates in a boost conversion or a buck conversion according to the first target voltage or the second target voltage.

In one embodiment, the first set of PWM signals determines a duty cycle for switching the first terminal of the inductor between the two voltage levels of the first set of divided voltages, and the second set of PWM signals determines a duty cycle for switching the first terminal of the inductor between the two voltage levels of the second set of divided voltages.

In one embodiment, a first start point of a first ramp signal is triggered at the end of every two consecutive first inductance periods, and another first start point of the first ramp signal is triggered at the end of every two consecutive second inductance periods. A second start point of a second ramp signal is triggered at the end of the first one of every two consecutive first inductance periods, and another second start point of the second ramp signal is triggered at the end of the first one of every two consecutive second inductance periods. The modulation circuit compares the first ramp signal and the second ramp signal with the first error amplification signal during the first inductance period to generate the first set of PWM signals. The modulation circuit also compares the first ramp signal and the second ramp signal with the second error amplification signal during the second inductance period to generate the second set of PWM signals. The two consecutive first inductance periods and the two consecutive second inductance periods are alternately arranged and sequentially repeated in cycles.

Compared to the prior art, the present invention provides significant improvements, particularly in reducing system size, improving efficiency, and enhancing power density. First, unlike traditional designs requiring multiple buck converters (each output voltage with a dedicated inductor and switch), the proposed single-inductor configuration supports multiple output voltages, simplifying circuit design and greatly reducing the number of required components. This improves the integration of the overall system and saves board space. The reduced physical volume not only benefits miniaturization but also enhances power density and operational efficiency.

Moreover, since only one inductor is required, as opposed to the conventional multiple-inductor approach, the size and cost of inductors are substantially reduced, which also simplifies system layout and lowers design and maintenance complexity. The inclusion of a switched capacitor voltage divider circuit effectively reduces the voltage stress on the inductor, thereby lowering the need for high-voltage-rated switching components and extending system lifespan. Lower-rated switches can thus be used to reduce cost and footprint.

Compared to the high switching loss typically encountered in conventional systems, the present invention improves energy efficiency through the use of ZCS (zero-current switching). These efficient soft-switching techniques allow switches to operate near zero current, reducing switching loss and electromagnetic interference (EMI), and increasing overall efficiency. This optimizes the energy conversion process and demonstrates strong potential for energy saving.

Finally, the present invention eliminates the need for additional capacitor balancing control circuits, which are often required in conventional multi-capacitor systems. The switched-capacitor operation naturally achieves dynamic charge balance during each conversion cycle, greatly simplifying control circuit design, improving system stability and reliability, and reducing design complexity. Overall, the invention overcomes limitations of prior art and provides a more efficient, compact, and user-friendly solution.

Compared to conventional multi-channel buck converters that require a separate inductor for each output, the present invention supports multiple outputs using a single inductor. By integrating inductor resources with the switched-capacitor architecture, it reduces the use of bulky inductors and avoids layout inefficiencies caused by stacked inductors. The reduced component count also lowers mutual interference among components, enhancing design efficiency and system reliability.

In terms of power density, by retaining only a single inductor and reducing its inductance value, the converter's size can be significantly minimized, which helps increase the overall power density. Furthermore, the high-efficiency switched-capacitor conversion mechanism reduces conduction and switching losses during energy transfer, thereby improving system efficiency. Higher efficiency also leads to lower heat generation, simplifying thermal design and improving overall system reliability and portability.

In terms of switch design, the hybrid switching converter utilizes voltage step-up or division to significantly reduce voltage stress on switches. This allows the use of lower-voltage-rated switches, reducing cost and size. When combined with zero-current or zero-voltage switching (ZCS/ZVS), switching loss and EMI are also mitigated, further enhancing efficiency and noise suppression.

Additionally, the system architecture does not require extra flying capacitor balancing control circuits. The switched-capacitor operation inherently achieves charge balance in each conversion cycle, greatly simplifying design complexity and reducing hardware cost. With these advantages, the present invention achieves higher power density and efficiency while lowering system complexity, thus offering superior performance for multi-output power applications compared to the prior art.

The objectives, technical details, features, and effects of the present invention will be better understood with regard to the detailed description of the embodiments below, with reference to the attached drawings.

### BRIEF DESCRIPTION OF THE DRAWINGS

FIG. 1 is a schematic diagram illustrating a conventional switching converter with multiple outputs.

FIGS. 2A and 2B are block circuit diagrams illustrating a hybrid switching converter with a single inductor and multiple outputs according to an embodiment of the present invention.

FIG. 3 is a schematic diagram illustrating a more specific embodiment of a sub-switching converter 21 in the hybrid switching converter 20 with a single inductor and multiple outputs shown in FIG. 2.

FIG. 4 is a schematic diagram illustrating a more specific embodiment of a control circuit 213 in the hybrid switching converter 20 shown in FIG. 2.

FIG. 5 is a schematic diagram illustrating another specific embodiment of the control circuit 213 in the hybrid switching converter 20 shown in FIG. 2.

FIG. 6 is a schematic diagram illustrating a ramp signal generation circuit of the control circuit according to an embodiment of the present invention.

FIG. 7 is a schematic diagram illustrating yet another specific embodiment of the control circuit 213 in the hybrid switching converter 20 shown in FIG. 2.

FIG. 8 is a schematic diagram illustrating a logic circuit of the control circuit according to an embodiment of the present invention.

FIG. 9 is a schematic diagram illustrating a current sensing circuit of the control circuit according to an embodiment of the present invention.

FIG. 10 is a waveform diagram illustrating signals associated with the hybrid switching converter with a single inductor and multiple outputs according to an embodiment of the present invention.

FIG. 11 is another waveform diagram illustrating signals associated with the hybrid switching converter with a single inductor and multiple outputs according to an embodiment of the present invention.

FIG. 12 is yet another waveform diagram illustrating signals associated with the hybrid switching converter with a single inductor and multiple outputs according to an embodiment of the present invention.

FIG. 13 is a schematic diagram illustrating another specific embodiment of the sub-switching converter 21 in the hybrid switching converter 20 with a single inductor and multiple outputs shown in FIG. 2.

FIG. 14A is a schematic diagram illustrating a logic circuit according to an embodiment of the present invention.

FIG. 14B is a schematic diagram illustrating a time-division switching control signal Sab in a normal mode of operation for a hybrid switching converter with a single inductor and multiple outputs according to an embodiment of the present invention.

FIG. 14C is a schematic diagram illustrating a time-division switching control signal Sab in a skip mode of operation for a hybrid switching converter with a single inductor and multiple outputs according to an embodiment of the present invention.

FIG. 14D is a schematic diagram illustrating a time-division switching control signal Sab in another skip mode of operation for a hybrid switching converter with a single inductor and multiple outputs according to an embodiment of the present invention.

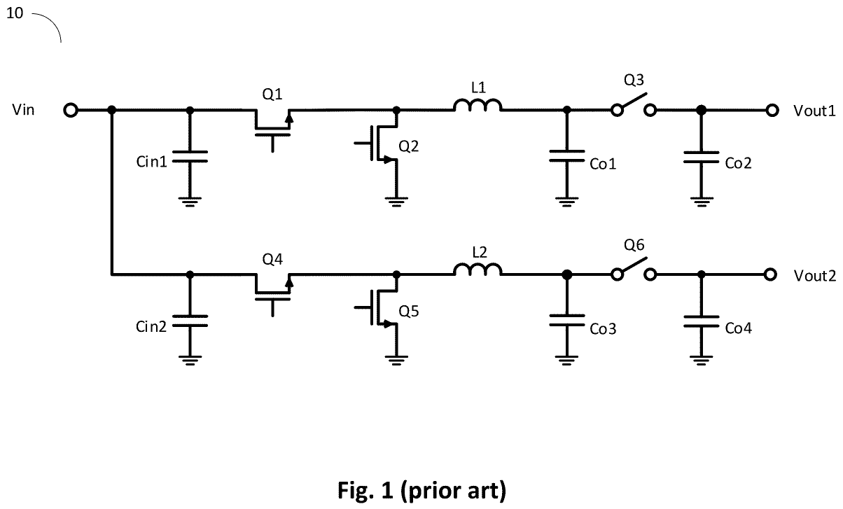

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

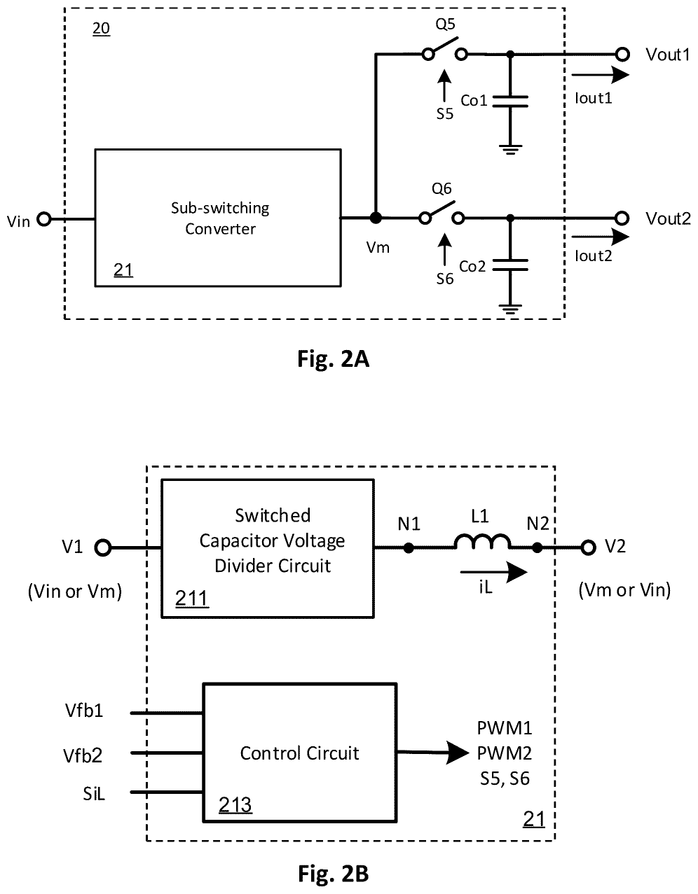

FIGS. 2A and 2B are block circuit diagrams illustrating a hybrid switching converter with a single inductor and multiple outputs according to an embodiment of the present invention. As shown in FIG. 2A, the hybrid switching converter 20 with a single inductor and multiple outputs is configured to convert an input voltage Vin to a first output voltage Vout1 and a second output voltage Vout2, and correspondingly generate a first output current Iout1 and a second output current Iout2. The hybrid switching converter 20 includes a sub-switching converter 21, a first output switch Q5, and a second output switch Q6. The sub-switching converter 21 converts the input voltage Vin to an intermediate voltage Vm. The first output switch Q5 is coupled between the intermediate voltage Vm and the first output voltage Vout1, and is turned ON during a first inductance period according to a first time-division signal S5 to convert the intermediate voltage Vm to the first output voltage Vout1. The second output switch Q6 is coupled between the intermediate voltage Vm and the second output voltage Vout2, and is turned ON during a second inductance period according to a second time-division signal S6 to convert the intermediate voltage Vm to the second output voltage Vout2.

Referring next to FIG. 2B, the sub-switching converter 21 includes a switched capacitor voltage divider circuit 211, an inductor L1, and a control circuit 213. During the first inductance period, the switched capacitor voltage divider circuit 211 performs a switched-capacitor operation by controlling multiple switches (not shown, to be described later) according to a first set of PWM signals PWM1 to convert a first voltage V1 to a first set of divided voltages with two different voltage levels. During the second inductance period, the switched capacitor voltage divider circuit 211 performs a switched-capacitor operation by controlling the switches according to a second set of PWM signals PWM2 to convert the first voltage V1 to a second set of divided voltages with two different voltage levels. The inductor L1 has a first terminal N1 and a second terminal N2. The first terminal N1 is coupled to the switched capacitor voltage divider circuit 211, and the second terminal N2 is coupled to a second voltage V2. During the first inductance period, the first terminal N1 of the inductor L1 is switched between the two voltage levels of the first set of divided voltages based on the duty ratio of the first set of PWM signals PWM1. During the second inductance period, the first terminal N1 of the inductor L1 is switched between the two voltage levels of the second set of divided voltages based on the duty ratio of the second set of PWM signals PWM2. In other words, the first set of PWM signals PWM1 determines the duty ratio for switching the first terminal N1 of the inductor L1 between the two voltage levels of the first set of divided voltages, while the second set of PWM signals PWM2 determines the duty ratio for switching the first terminal N1 between the two voltage levels of the second set of divided voltages. The control circuit 213 is configured to generate the first set of PWM signals PWM1, the second set of PWM signals PWM2, the first time-division signal S5, and the second time-division signal S6 to time-divisionally control the switches in the switched capacitor voltage divider circuit 211, the first output switch Q5, and the second output switch Q6, and to periodically magnetize and demagnetize the same inductor L1 during the first and second inductance periods to perform power conversion between the first voltage V1 and the second voltage V2, and correspondingly generate the first and second output voltages Vout1 and Vout2.

The first voltage V1 and the second voltage V2 respectively correspond to either the input voltage Vin or the intermediate voltage Vm. In one embodiment, the first voltage V1 is the input voltage Vin and the second voltage V2 is the intermediate voltage Vm, in which case the switched capacitor voltage divider circuit 211 and the inductor L1 are configured in a buck topology, such that the intermediate voltage Vm is lower than the input voltage Vin without requiring additional switches. In another embodiment, the first voltage V1 is the intermediate voltage Vm and the second voltage V2 is the input voltage Vin, in which case the switched capacitor voltage divider circuit 211 and the inductor L1 are configured in a boost topology, such that the intermediate voltage Vm is higher than the input voltage Vin.

The control circuit 213 is further configured to adjust the first output voltage Vout1 to a first target voltage based on a first feedback signal Vfb1 related to the first output voltage Vout1 during the first inductance period, and adjust the second output voltage Vout2 to a second target voltage based on a second feedback signal Vfb2 related to the second output voltage Vout2 during the second inductance period. The hybrid switching converter 20 with a single inductor and multiple outputs operates in a boundary conduction mode (BCM) or a discontinuous conduction mode (DCM) during the first and second inductance periods.

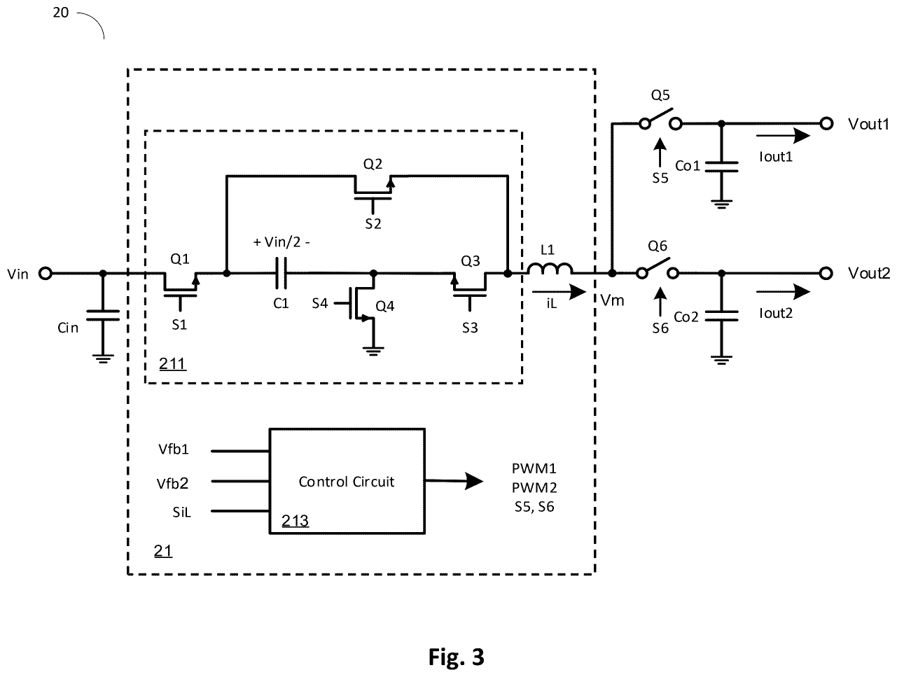

FIG. 3 is a schematic diagram illustrating a more specific embodiment of the sub-switching converter 21 in the hybrid switching converter 20 shown in FIG. 2. As shown in FIG. 3, the sub-switching converter 21 includes the switched capacitor voltage divider circuit 211, the inductor L1, and the control circuit 213. In this embodiment, the first voltage V1 is, for example, the input voltage Vin, and the second voltage V2 is the intermediate voltage Vm. The switched capacitor voltage divider circuit 211 and the inductor L1 are configured in a buck topology. The switched capacitor voltage divider circuit 211, for example, includes switches Q1, Q2, Q3, Q4, and a flying capacitor C1. The switched capacitor voltage divider circuit 211 converts the input voltage Vin to two different voltage levels through a switched-capacitor voltage division. Switches Q1 through Q4 are sequentially connected in series between the input voltage Vin and ground, and the flying capacitor C1 is connected in parallel with the series-connected switches Q2 and Q3. By appropriately operating switches Q1-Q4, the flying capacitor C1 can be charged to a specific voltage level during one time interval and then reconfigured to an output node of the switched capacitor voltage divider circuit 211 during another phase to realize a voltage division of the input voltage Vin into two different levels. In this embodiment, under steady-state operation, the switched capacitor voltage divider circuit 211 can convert the input voltage Vin to two of three voltage levels, including the input voltage Vin, one-half of the input voltage Vin, and ground potential, for supply to the first terminal N1 of the inductor L1, so that the terminal N1 switches between two different voltage levels.

It should be noted that the present invention is not limited to a configuration in which the switched capacitor voltage divider circuit 211 includes only one flying capacitor C1. The circuit may include more flying capacitors to provide more voltage divisions and is not limited to three voltage levels. That is, the switched capacitor voltage divider circuit 211 may convert the input voltage Vin to two voltage levels selected from at least three different voltage levels for supply to the first terminal N1 of the inductor L1, such that terminal N1 switches between two different voltage levels.

In this embodiment, the first set of PWM signals PWM1 refers to the PWM signals S1 to S4 generated during the first inductance period, and the second set of PWM signals PWM2 refers to the PWM signals S1 to S4 generated during the second inductance period. The PWM signals S1 to S4 respectively control switches Q1 to Q4. The two different voltage levels of the first set of divided voltages may, for example, be one-half of the input voltage Vin and ground. The two different voltage levels of the second set of divided voltages may also be one-half of the input voltage Vin and ground. In other words, during the first inductance period, the first set of PWM signals PWM1 converts the input voltage Vin to two voltage levels: one-half of the input voltage Vin and ground. During the second inductance period, the second set of PWM signals PWM2 performs the same conversion. The detailed operation will be described later.

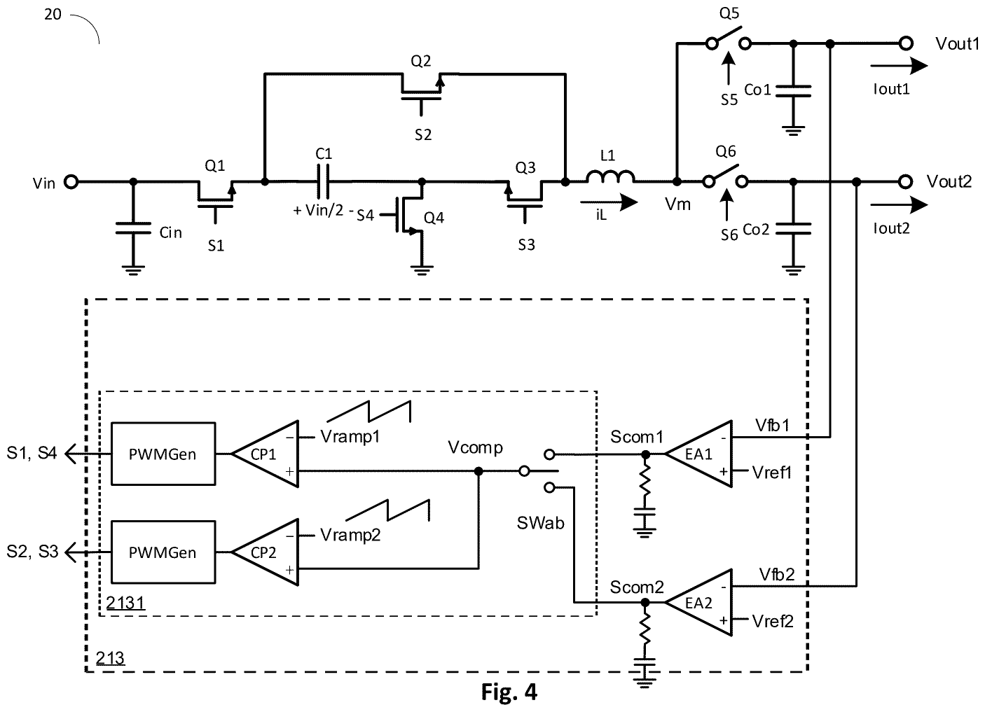

FIG. 4 is a schematic diagram illustrating a more specific embodiment of the control circuit 213 in the hybrid switching converter 20 shown in FIG. 2. As shown in FIG. 4, the control circuit 213 includes a first error amplifier EA1, a second error amplifier EA2, and a modulation circuit 2131. The first error amplifier EA1 amplifies the difference between the first output voltage feedback signal Vfb1 and a first reference signal Vref1 to generate a first error amplification signal Scom1. The second error amplifier EA2 amplifies the difference between the second output voltage feedback signal Vfb2 and a second reference signal Vref2 to generate a second error amplification signal Scom2. The first reference signal Vref1 corresponds to a target voltage of the first output voltage Vout1, and the second reference signal Vref2 corresponds to a target voltage of the second output voltage Vout2.

The modulation circuit 2131 is configured to generate the first set of PWM signals PWM1 based on the first error amplification signal Scom1 during the first inductance period, and to generate the second set of PWM signals PWM2 based on the second error amplification signal Scom2 during the second inductance period. The first set of PWM signals PWM1 refers to the PWM signals S1 to S4 during the first inductance period, and the second set of PWM signals PWM2 refers to the PWM signals S1 to S4 during the second inductance period.

Referring also to FIG. 4, in this embodiment, the modulation circuit 2131 includes a time-division switch SWab, comparators CP1 and CP2, and two PWM signal generation circuits PWMGen. During the first inductance period, the time-division switch SWab electrically connects the first error amplifier EA1 to the comparators CP1 and CP2, thereby transmitting the first error amplification signal Scom1 to the comparators as an error signal Vcomp, which is compared with a first ramp signal Vramp1 and a second ramp signal Vramp2, respectively. During the second inductance period, the time-division switch SWab electrically connects the second error amplifier EA2 to the comparators CP1 and CP2, thereby transmitting the second error amplification signal Scom2 to the comparators as the error signal Vcomp, which is also compared with the ramp signals Vramp1 and Vramp2, respectively.

In this embodiment, during the first inductance period, the comparator CP1 compares the first error amplification signal Scom1 with the first ramp signal Vramp1, and the comparison result is processed by a corresponding PWM signal generation circuit PWMGen to generate PWM signals S1 and S4. The comparator CP2 compares the first error amplification signal Scom1 with the second ramp signal Vramp2, and the comparison result is used to generate PWM signals S2 and S3. These PWM signals S1-S4 constitute the first set of PWM signals PWM1 during the first inductance period.

In this embodiment, during the second inductance period, the comparator CP1 compares the second error amplification signal Scom2 with the first ramp signal Vramp1. The comparison result is processed by the corresponding PWM signal generation circuit PWMGen to generate PWM signals S1 and S4 in the second inductance period. Similarly, the comparator CP2 compares the second error amplification signal Scom2 with the second ramp signal Vramp2, and the comparison result is used to generate PWM signals S2 and S3. The PWM signals S1 to S4 generated in the second inductance period constitute the second set of PWM signals PWM2.

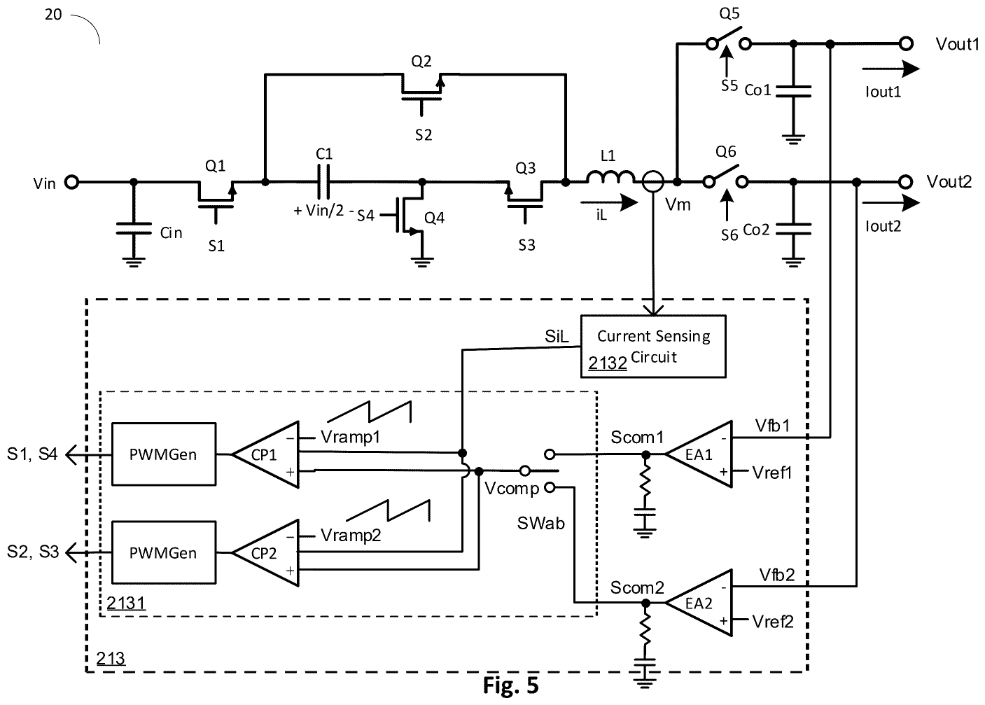

FIG. 5 is a schematic diagram illustrating another specific embodiment of the control circuit 213 in the hybrid switching converter 20 shown in FIG. 2. Compared with the embodiment shown in FIG. 4, the control circuit 213 in this embodiment further includes a current sensing circuit 2132 configured to sense an inductor current iL flowing through the inductor L1 and generate an inductor current signal SiL. The modulation circuit 2131 further generates the first set of PWM signals PWM1 and the second set of PWM signals PWM2 based on the inductor current signal SiL.

For example, the comparator CP1 may compare the sum of the inductor current signal SiL and the first ramp signal Vramp1 with the error signal Vcomp to generate PWM signals S1 and S4. Alternatively, the comparator CP1 may compare the sum of the error signal Vcomp and the inductor current signal SiL with the first ramp signal Vramp1 to generate PWM signals S1 and S4. In another approach, the comparator CP1 may first compare the error signal Vcomp with the first ramp signal Vramp1, and then add the inductor current signal SiL to the comparison result to generate PWM signals S1 and S4.

Similarly, the comparator CP2 may compare the sum of the inductor current signal SiL and the second ramp signal Vramp2 with the error signal Vcomp to generate PWM signals S2 and S3. Alternatively, the comparator CP2 may compare the sum of the error signal Vcomp and the inductor current signal SiL with the second ramp signal Vramp2 to generate PWM signals S2 and S3. In another case, the comparator CP2 may first compare the error signal Vcomp with the second ramp signal Vramp2, and then add the inductor current signal SiL to the comparison result to generate PWM signals S2 and S3.

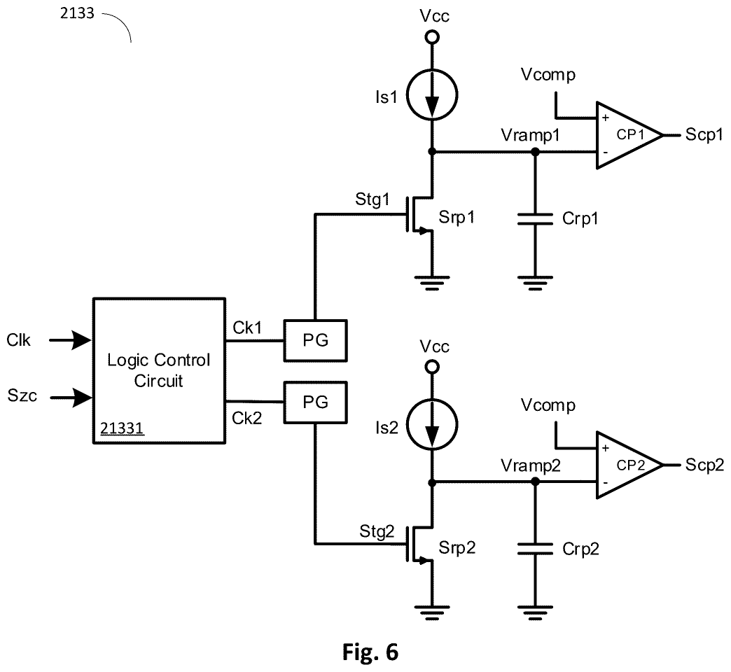

FIG. 6 is a schematic diagram illustrating a ramp signal generation circuit of the control circuit according to an embodiment of the present invention. The control circuit 213 may further include a ramp signal generation circuit 2133. As shown in FIG. 6, the ramp signal generation circuit 2133 includes a logic control circuit 21331, two pulse generators PG, a first current source Is1, a first reset switch Srp1, a capacitor Crp1, a second current source Is2, a second reset switch Srp2, and a capacitor Crp2. Under a boundary conduction mode (BCM), the logic control circuit 21331 generates switching clock signals Ck1 and Ck2 based on a zero current signal Szc. Under a discontinuous conduction mode (DCM), the logic control circuit 21331 generates the switching clock signals Ck1 and Ck2 based on a clock signal Clk. In one embodiment, the clock signal Clk may be a clock signal with a fixed period, or a clock signal determined by the zero current signal Szc and the control loop. The two pulse generators PG respectively generate trigger signals Stg1 and Stg2 based on the switching clock signals Ck1 and Ck2. Both current sources Is1 and Is2 are coupled to an internal voltage Vcc and powered by an internal power supply.

The first reset switch Srp1 operates based on the trigger signal Stg1 to control the charging and discharging of the capacitor Crp1 by the current source Is1, thereby generating a first ramp signal Vramp1 across the capacitor Crp1. In one embodiment, after the trigger signal Stg1 is activated, when the first ramp signal Vramp1 is lower than the error signal Vcomp, the comparator CP1 generates a first comparison signal Scp1 to control the corresponding PWM signal generation circuit PWMGen to generate PWM signals S1 and S4.

The second reset switch Srp2 operates based on the trigger signal Stg2 to control the charging and discharging of the capacitor Crp2 by the current source Is2, thereby generating a second ramp signal Vramp2 across the capacitor Crp2. In one embodiment, after the trigger signal Stg2 is activated, when the second ramp signal Vramp2 is lower than the error signal Vcomp, the comparator CP2 generates a second comparison signal Scp2 to control the corresponding PWM signal generation circuit PWMGen to generate PWM signals S2 and S3.

In this embodiment, a phase shift exists between the first ramp signal Vramp1 and the second ramp signal Vramp2. The ramp signals Vramp1 and Vramp2 are synchronized with the switching clock signals Ck1 and Ck2, respectively. Therefore, the phase shift between Vramp1 and Vramp2 corresponds to the phase shift between the switching clock signals Ck1 and Ck2.

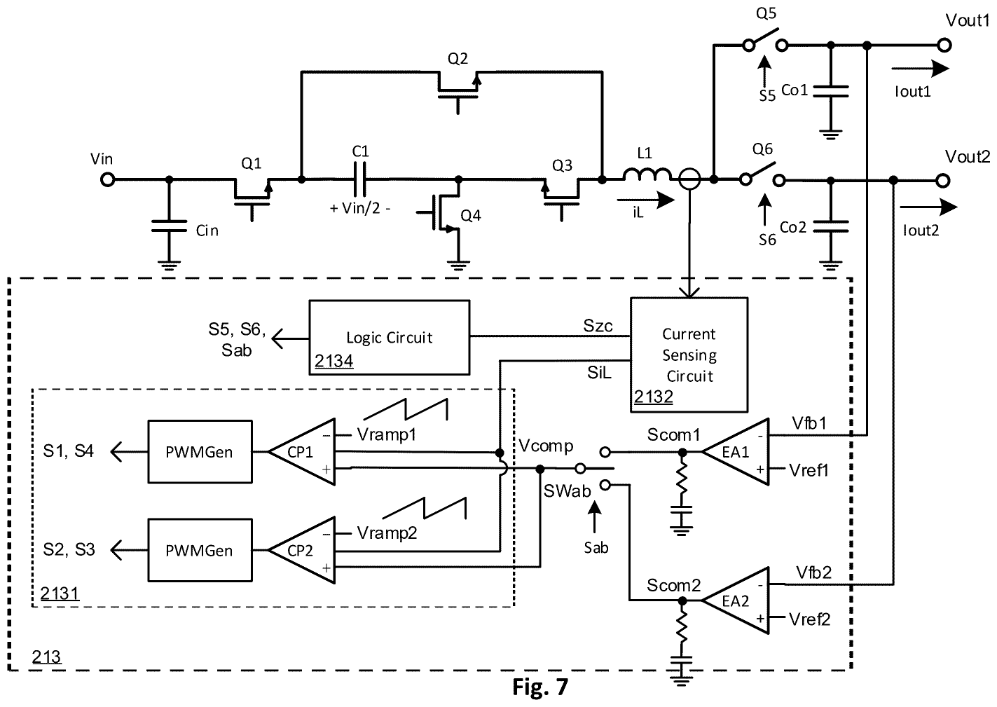

FIG. 7 is a schematic diagram illustrating yet another specific embodiment of the control circuit 213 in the hybrid switching converter 20 shown in FIG. 2. Compared with the control circuit 213 shown in FIG. 5, the current sensing circuit 2132 in this embodiment further generates a zero current signal Szc when the inductor current iL becomes zero current Izc. The control circuit 213 further includes a logic circuit 2134 configured to generate a first time-division signal S5, a second time-division signal S6, and a time-division switching control signal Sab based on the zero current signal Szc. The time-division switching control signal Sab is used to control a time-division switch SWab, such that the switch SWab connects the first error amplifier EA1 to comparators CP1 and CP2 during the first inductance period and connects the second error amplifier EA2 to comparators CP1 and CP2 during the second inductance period.

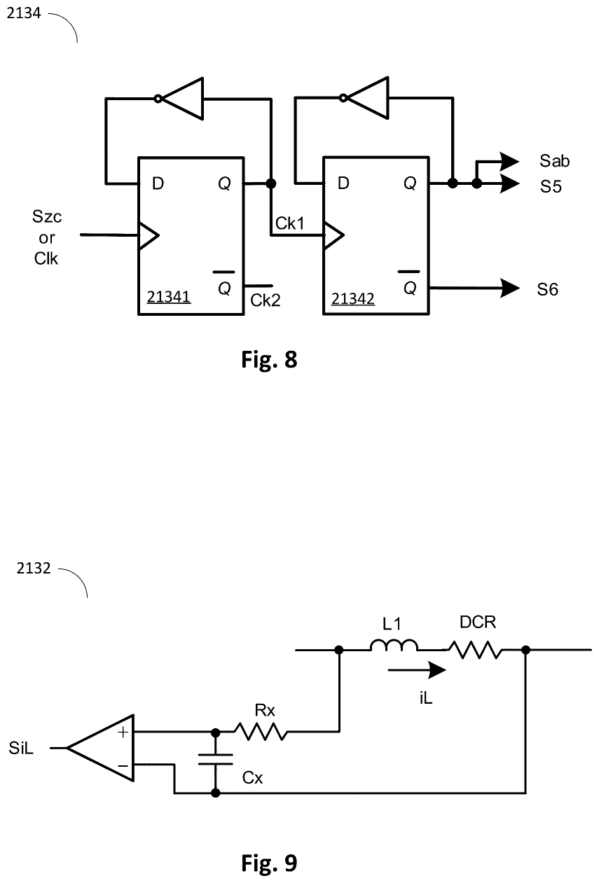

FIG. 8 is a schematic diagram illustrating a logic circuit of the control circuit according to an embodiment of the present invention. As in the embodiment shown in FIG. 7, the control circuit 213 further includes the logic circuit 2134. In this embodiment, as shown in FIG. 8, the logic circuit 2134 includes two D-type flip-flops 21341 and 21342 connected in series. The D input of flip-flop 21341 receives the inverted signal of its own Q output. When the clock input receives either the zero current signal Szc or the clock signal Clk, the internal logic triggers a state transition and generates a switching clock signal Ck1 at the Q output and a switching clock signal Ck2 at the inverted Q′ output. The D input of flip-flop 21342 receives the inverted signal of its Q output, and its clock input receives the switching clock signal Ck1 as the trigger signal. The Q output of flip-flop 21342 generates the first time-division signal S5 and the time-division switching control signal Sab. The signal S5 controls the first output switch Q5, while the control signal Sab controls the time-division switch SWab. The inverted Q′ output of flip-flop 21342 generates the second time-division signal S6, which controls the second output switch Q6.

When the switching clock signal Ck1 is input to the second D-type flip-flop 21342, the second D-type flip-flop 21342 updates its internal state according to a predetermined timing relationship and generates the first time-division signal S5 and the second time-division signal S6 based on its complementary output characteristics. In this way, the two time-division signals (S5 and S6) alternately control the first output switch Q5 and the second output switch Q6 in a time-division manner, thereby generating the corresponding first output voltage Vout1 and second output voltage Vout2 during the periodic first and second inductance periods, respectively.

In addition to controlling the first output switch Q5 and the second output switch Q6, the time-division switching control signal Sab generated from the Q output of the second D-type flip-flop 21342 is also used to operate the time-division switch SWab as previously described.

FIG. 9 is a schematic diagram illustrating a current sensing circuit of the control circuit according to an embodiment of the present invention. As in the embodiment shown in FIG. 5, the control circuit 213 may include a current sensing circuit 2132. In this embodiment, as shown in FIG. 9, the current sensing circuit 2132 includes a sensing resistor Rx and a sensing capacitor Cx. The sensing resistor Rx and the sensing capacitor Cx are connected in series and coupled to the inductor L1. The inductor current iL is sensed by the voltage across the sensing capacitor Cx to generate an inductor current signal SiL. The time constant of the sensing resistor Rx and the sensing capacitor Cx matches the time constant of the inductor L1 and the DC resistance (DCR) of the inductor L1.

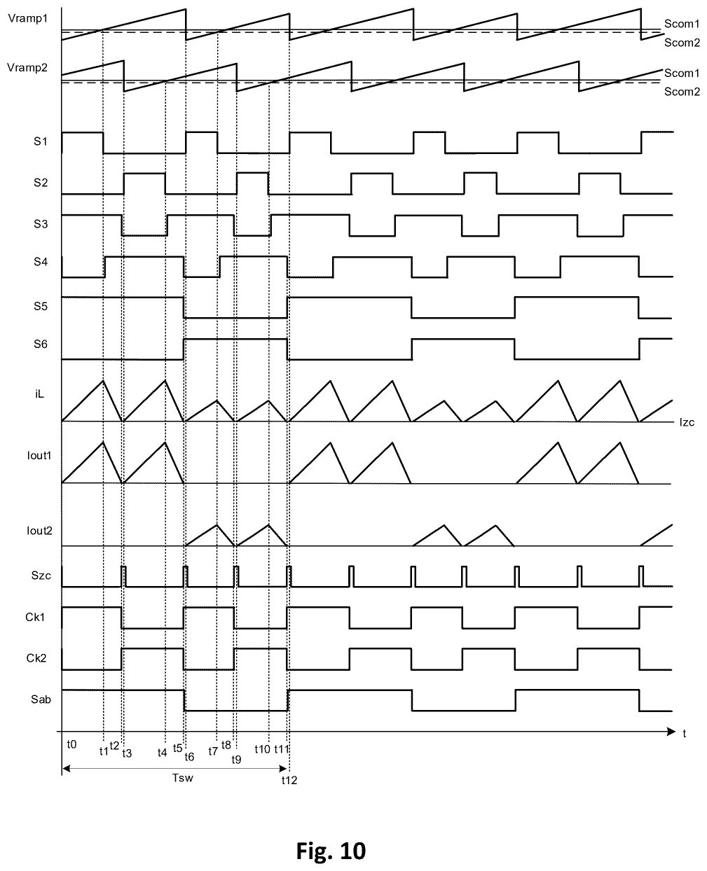

FIG. 10 is a signal waveform diagram illustrating signals associated with a hybrid switching converter with a single inductor and multiple outputs according to an embodiment of the present invention. The horizontal axis represents time t, while the vertical axis shows signal waveforms corresponding to each signal. This embodiment uses two periodic first inductance periods and two second inductance periods as an example. Time t0 to t12 denotes a unit cycle Tsw, which includes two consecutive first inductance periods and two consecutive second inductance periods. In this embodiment, the hybrid switching converter operates in boundary conduction mode (BCM) during each first and second inductance period. It should be noted that the unit cycle Tsw refers to a complete switching and energy conversion cycle for all outputs in a hybrid switching converter with a single inductor, which continuously and periodically repeats during operation.

During time t0 to t3, the converter is in a first inductance period. The time-division switching control signal Sab controls the time-division switch SWab to be, for example, in a high level state, electrically connecting the first error amplifier EA1 to comparators CP1 and CP2. At the same time, the first time-division signal S5 turns ON the first output switch Q5, while the second time-division signal S6 does not turn ON the second output switch Q6. From t0 to t1, the first error amplification signal Scom1 is greater than the first ramp signal Vramp1, making the PWM signal S1 high and causing switch Q1 to conduct. Meanwhile, Scom1 is less than the second ramp signal Vramp2, so PWM signal S2 is low, and Q2 is not conducting; PWM signal S3, being the complement of S2, is high, turning ON Q3; PWM signal S4, being the complement of S1, is low, so Q4 is OFF. Thus, during t0 to t1, Q1 and Q3 are ON, Q2 and Q4 are OFF, and the inductor L1 is connected in series with the flying capacitor C1 between the input voltage Vin and the first output voltage Vout1. In this state, capacitor C1 charges, and the voltage at terminal N1 of inductor L1 is one-half of Vin (i.e., Vin−Vin/2). The inductor is magnetized, the inductor current iL rises, and the first output current Iout1 increases accordingly.

From t1 to t2, Scom1 is less than Vramp1, so PWM signal S1 is low and Q1 is OFF. Scom1 is also less than Vramp2, so PWM signal S2 is low and Q2 is OFF. Therefore, PWM signal S3 is high (Q3 is ON), and PWM signal S4 is high (Q4 is ON). Thus, during t1 to t2, Q1 and Q2 are OFF, Q3 and Q4 are ON, and the first terminal N1 of inductor L1 is connected to a reference potential (ground in this embodiment). The inductor is demagnetized, iL decreases, and Iout1 also decreases. In other words, during t0 to t2, terminal N1 of inductor L1 switches between one-half of Vin and the ground reference.

At time t2, the current sensing circuit 2132 detects that the inductor current iL reaches zero current Izc and generates the zero current signal Szc. The logic control circuit 21331 then switches clock signals Ck1 and Ck2 based on the zero current signal Szc, thereby ending the first inductance period. From t2 to t3, the system enters a preset dead time, during which iL remains at zero current Izc. Then, at t3, the next first inductance period begins. It should be noted that the interval from t0 to t3 constitutes a complete first inductance period, including magnetization (from iL=Izc to when Scom1>Vramp1), demagnetization (from Scom1>Vramp1 to iL=Izc), and the preset dead time.

From t3 to t6, the converter enters another first inductance period. During this period, the time-division switching control signal Sab remains high to connect EA1 to CP1 and CP2. The first time-division signal S5 turns ON Q5, and S6 remains OFF. From t3 to t4, Scom1<Vramp1, so S1 is low and Q1 is OFF; Scom1>Vramp2, so S2 is high and Q2 is ON; S3 is low and Q3 is OFF; S4 is high and Q4 is ON. As a result, C1 is discharged, and L1 is connected in parallel with C1. The voltage at N1 is Vin/2 (i.e., the voltage across C1). The inductor is magnetized, iL increases, and Iout1 also increases.

From t4 to t5, Scom1<Vramp1 and <Vramp2, so S1 and S2 are both low. Consequently, Q1 and Q2 are OFF; S3 and S4 are high (complements of S2 and S1), so Q3 and Q4 are ON. Thus, L1's terminal N1 connects to the reference potential, L1 demagnetizes, iL decreases, and Iout1 also decreases. During t3 to t5, terminal N1 of L1 switches between Vin/2 and ground. Since L1's terminal N1 switches between Vin/2 and ground in two consecutive first inductance periods, the first output voltage Vout1 is between Vin/2 and ground.

At time t5, the current sensing circuit 2132 detects that iL has reached zero current Izc and generates the zero current signal Szc. The logic control circuit 21331 switches clock signals Ck1 and Ck2 based on Szc, thereby ending another first inductance period. From t5 to t6, the system enters a preset dead time, maintaining iL=Izc. At t6, a second inductance period begins.

From time t6 to t9, the hybrid switching converter with a single inductor and multiple outputs enters the second inductance period. During this period, the time-division switching control signal Sab controls the time-division switch SWab to, for example, a low level, electrically connecting the second error amplifier EA2 to the comparators CP1 and CP2. The first time-division signal S5 keeps the first output switch Q5 OFF, while the second time-division signal S6 turns ON the second output switch Q6. From time t6 to t7, the second error amplification signal Scom2 is greater than the first ramp signal Vramp1, so the PWM signal S1 is high and Q1 is ON. At the same time, Scom2 is less than the second ramp signal Vramp2, so PWM signal S2 is low (Q2 is OFF), PWM signal S3 is high (Q3 is ON), and PWM signal S4 is low (Q4 is OFF). As a result, during t6 to t7, Q1 and Q3 are ON, Q2 and Q4 are OFF, the inductor L1 and flying capacitor C1 are connected in series between Vin and Vout1, and C1 charges. The voltage at inductor terminal N1 is half of Vin, L1 is magnetized, the inductor current iL rises, and the second output current Iout2 increases accordingly.

From time t7 to t8, Scom2 is less than Vramp1 and Vramp2, so PWM signals S1 and S2 are low (Q1 and Q2 OFF), S3 and S4 are high (Q3 and Q4 ON). Thus, terminal N1 of L1 connects to the reference potential (ground in this embodiment), L1 is demagnetized, iL decreases, and Iout2 also decreases. In other words, from t6 to t8, terminal N1 switches between half of Vin and ground.

At time t8, the current sensing circuit 2132 detects iL=Izc and generates the zero current signal Szc. The logic control circuit 21331 switches clock signals Ck1 and Ck2 according to Szc to end the second inductance period. From t8 to t9, the system enters a preset dead time in which iL remains at zero. Then at t9, another second inductance period begins. From t6 to t9 completes one full second inductance period, including magnetization (from iL=0 to Scom2>Vramp1), demagnetization (from Scom2>Vramp1 to iL=0), and dead time.

From time t9 to t12, the converter enters another second inductance period. Sab remains low, EA2 connects to CP1 and CP2, S5 remains OFF, and S6 turns ON Q6. From t9 to t10, Scom2<Vramp1 (S1 low, Q1 OFF), Scom2>Vramp2 (S2 high, Q2 ON), S3 low (Q3 OFF), S4 high (Q4 ON). Therefore, L1 and C1 are connected in parallel, C1 discharges, terminal N1=Vin/2, L1 is magnetized, iL rises, and Iout2 increases.

From t10 to t11, Scom2<both Vramp1 and Vramp2, so S1 and S2 are low (Q1 and Q2 OFF), S3 and S4 are high (Q3 and Q4 ON). Therefore, L1 terminal N1 connects to ground, L1 is demagnetized, iL decreases, and Iout2 decreases. Thus, from t9 to t11, terminal N1 switches between Vin/2 and ground. Since N1 switches this way in two consecutive second inductance periods, the resulting second output voltage Vout2 is between Vin/2 and ground.

At time t11, the current sensing circuit 2132 detects iL=0 and generates Szc. The logic control circuit 21331 switches Ck1 and Ck2 according to Szc to end another second inductance period. From t11 to t12, the system enters the preset dead time with iL=0. Then, at t12, the next first inductance period begins.

In this embodiment, the flying capacitor C1 charges and discharges across the two consecutive first inductance periods (e.g., t0-t3 and t3-t6), achieving balance and ensuring stable operation. Similarly, C1 also charges and discharges across the two consecutive second inductance periods (e.g., t6-t9 and t9-t12), again achieving charge balance and stability.

In addition, in this embodiment, the start of the first ramp signal Vramp1 is triggered at the end of every two consecutive first inductance periods and every two consecutive second inductance periods. The start of the second ramp signal Vramp2 is triggered at the end of the first inductance period among two consecutive first inductance periods, and again at the end of the first inductance period among two consecutive second inductance periods.

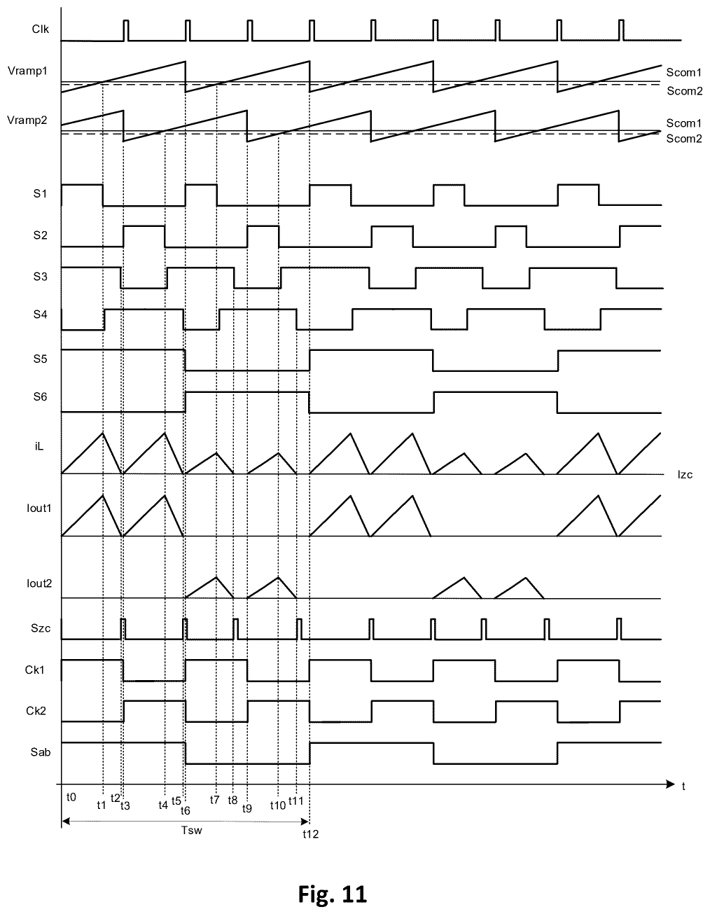

FIG. 11 is a waveform diagram illustrating signals associated with a hybrid switching converter with a single inductor and multiple outputs according to an embodiment of the present invention. In this example, the unit cycle Tsw includes two consecutive first inductance periods and two consecutive second inductance periods (t0 to t12). The converter operates in boundary conduction mode (BCM) during each first inductance period. Unlike FIG. 10, in this embodiment, the converter operates in discontinuous conduction mode (DCM) during each second inductance period.

In this embodiment, at t8, although the current sensing circuit 2132 detects iL=0 and generates Szc, the logic control circuit 21331 switches Ck1 and Ck2 based on the clock signal Clk instead of Szc. Therefore, the dead time from t8 to t9 is longer than that of the embodiment in FIG. 10. Likewise, at t11, Szc is generated when iL=0, but Clk, not Szc, is used to switch the clock signals and end the second inductance period. Thus, the dead time from t11 to t12 is also longer than that in FIG. 10. Other portions (t0 to t6, t6 to t8, and t9 to t11) are the same as described in FIG. 10; please refer to the description of FIG. 10.

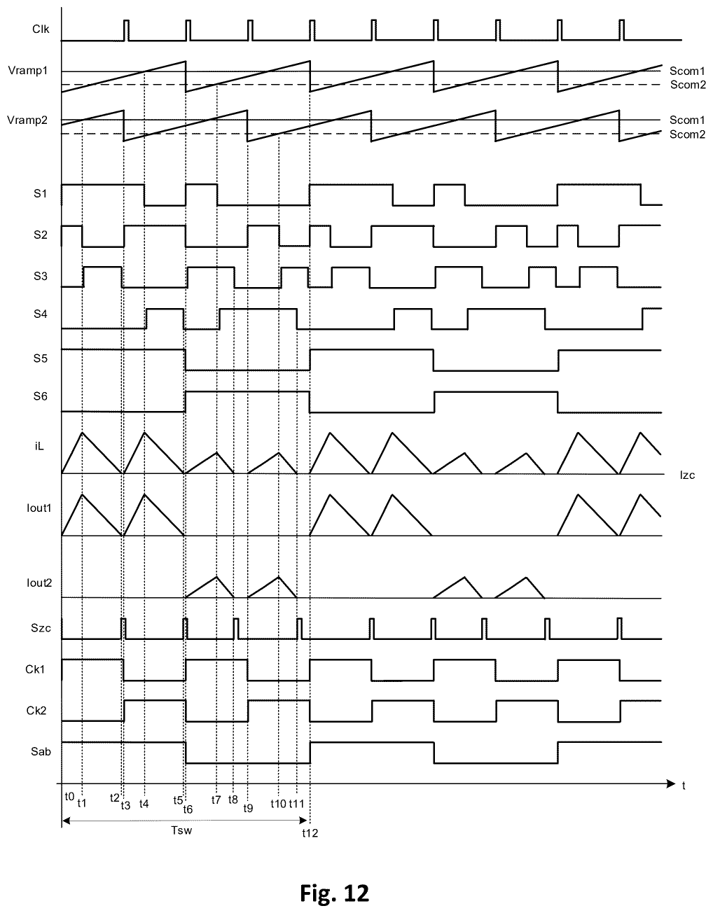

FIG. 12 is a waveform diagram illustrating signals associated with a hybrid switching converter with a single inductor and multiple outputs according to an embodiment of the present invention. Similar to the embodiment shown in FIG. 11, this embodiment also uses a repetitive sequence of two first inductance periods and two second inductance periods as an example, where time t0 to t12 represents a unit cycle Tsw that includes two consecutive first inductance periods and two consecutive second inductance periods. During each first inductance period, the converter operates in boundary conduction mode (BCM), and during each second inductance period, the converter operates in discontinuous conduction mode (DCM).

The difference between this embodiment and the embodiment shown in FIG. 11 is that the output voltage Vout1 in this embodiment lies between the input voltage Vin and one-half of Vin. Therefore, the first error amplification signal Scom1 has a relatively higher level, allowing the first terminal N1 of the inductor L1 to switch between Vin and one-half of Vin, instead of between one-half of Vin and the reference potential, as detailed below.

From time t0 to t3, the converter is in a first inductance period. During this time, the time-division switching control signal Sab sets the time-division switch SWab, for example, to a high level to connect the first error amplifier EA1 to comparators CP1 and CP2. The first time-division signal S5 turns ON Q5, while the second time-division signal S6 keeps Q6 OFF. From time t0 to t1, Scom1>Vramp1, so PWM signal S1 is high and Q1 is ON; Scom1>Vramp2, so PWM signal S2 is high and Q2 is ON; PWM signals S3 and S4 are both low, so Q3 and Q4 are OFF. Thus, during t0 to t1, Q1 and Q2 are ON, Q3 and Q4 are OFF, and inductor terminal N1 is coupled directly to Vin. The inductor L1 is magnetized, iL increases, and Iout1 increases accordingly.

From t1 to t2, Scom1>Vramp1 (S1 high, Q1 ON), Scom1<Vramp2 (S2 low, Q2 OFF), so S3 is high (Q3 ON), and S4 is low (Q4 OFF). Thus, L1 and C1 are connected in series between Vin and Vout1, C1 charges, terminal N1 is at Vin/2, L1 is demagnetized, iL decreases, and Iout1 decreases. In other words, from t0 to t2, terminal N1 switches between Vin and Vin/2.

At t2, the current sensing circuit 2132 detects iL=0 and generates the zero current signal Szc. The logic control circuit 21331 switches Ck1 and Ck2 based on Szc to end the first inductance period. From t2 to t3, the system enters a preset dead time, during which iL remains at zero. Then at t3, the next first inductance period begins. Note that from t0 to t3, the complete first inductance period includes magnetization (from iL=0 to Scom2>Vramp2), demagnetization (from Scom2>Vramp2 to iL=0), and the preset dead time.

From t3 to t6, the converter is in another first inductance period. Sab is high, EA1 is connected to CP1 and CP2, S5 turns ON Q5, and S6 keeps Q6 OFF. From t3 to t4, Scom1>both Vramp1 and Vramp2, so S1 and S2 are high (Q1 and Q2 ON), S3 and S4 are low (Q3 and Q4 OFF). Thus, N1 is coupled to Vin, L1 is magnetized, iL increases, and Iout1 increases accordingly.

From t4 to t5, Scom1<Vramp1 (S1 low, Q1 OFF), Scom1>Vramp2 (S2 high, Q2 ON), so S3 is low (Q3 OFF) and S4 is high (Q4 ON). Thus, C1 discharges while connected in parallel with L1, and N1=Vin/2. The inductor L1 is demagnetized, iL decreases, and Iout1 also decreases. In other words, from t3 to t5, terminal N1 switches between Vin and Vin/2.

At t5, iL=0 is detected by the current sensing circuit 2132, and Szc is generated. Based on Szc, the logic control circuit 21331 switches Ck1 and Ck2 to end the first inductance period. From t5 to t6, the system enters the dead time, maintaining iL=0. At t6, a second inductance period begins.

From t6 to t12, the converter goes through two consecutive second inductance periods. The operation during this interval is the same as the operation from t6 to t12 in FIG. 11. Please refer to the description of FIG. 11, which will not be repeated here.

In this embodiment, the flying capacitor achieves a balanced state across the two consecutive first inductance periods (e.g., t0 to t3 and t3 to t6), ensuring stable operation. Similarly, across the two consecutive second inductance periods (e.g., t6 to t9 and t9 to t12), the capacitor also reaches a balanced state, maintaining stability.

The starting point of the first ramp signal Vramp1 is triggered at the end of every two consecutive first inductance periods and every two consecutive second inductance periods. The starting point of the second ramp signal Vramp2 is triggered at the end of the first first inductance period among two consecutive first inductance periods, and again at the end of the first second inductance period among two consecutive second inductance periods.

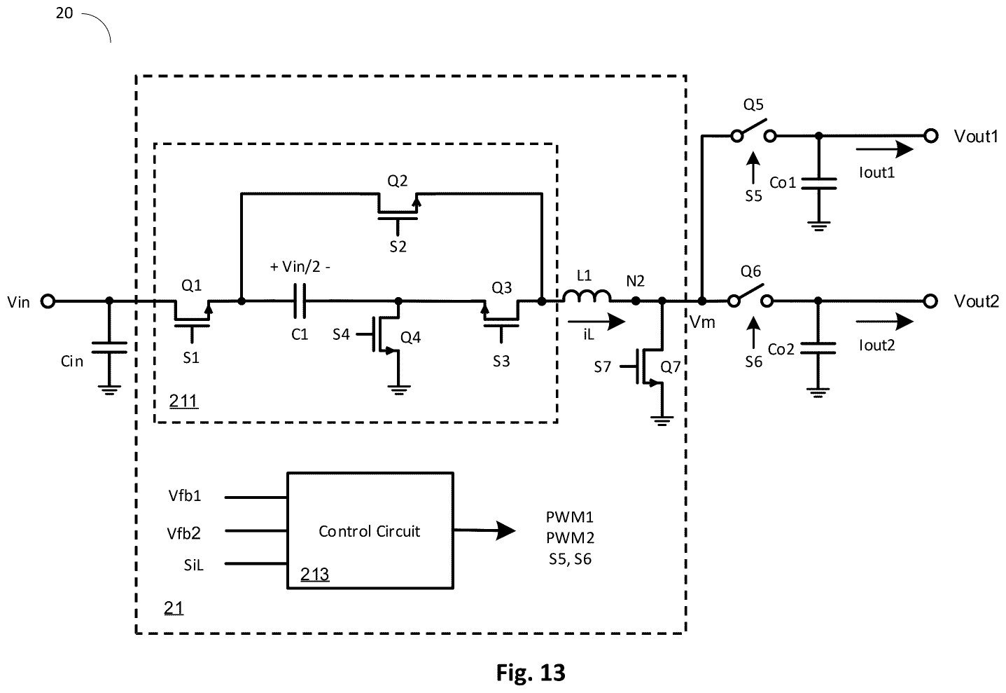

FIG. 13 is a schematic diagram illustrating another specific embodiment of the sub-switching converter 21 in the hybrid switching converter 20 with a single inductor and multiple outputs shown in FIG. 2. Compared to the embodiment in FIG. 3, this embodiment further includes a boost switch Q7 coupled between the second terminal N2 of the inductor L1 and a reference potential (ground in this embodiment), allowing the converter 20 to operate in either boost or buck mode depending on whether the first or second target voltage is higher than the input voltage Vin.

The boost switch Q7 enables flexibility in output voltage requirements. For example, when the first or second target voltage is higher than Vin, the boost switch Q7 operates in coordination with the first or second output switch (Q5 or Q6) to implement a boost conversion. In this configuration, the switched capacitor voltage divider circuit 211, the inductor L1, and the boost switch Q7 form a boost topology. The first terminal N1 of L1 may be electrically connected to Vin, and the inductor stores and releases energy to raise the output voltage above Vin.

On the other hand, when the first or second target voltage is lower than Vin, the boost switch Q7 is turned OFF, and the circuit comprising the switched capacitor voltage divider 211 and inductor L1 operates in a buck configuration. In this mode, L1 cooperates with the switched capacitor voltage divider circuit 211 to step down the input voltage Vin and provide a stable target voltage lower than Vin.

In one embodiment, the first terminal N1 of inductor L1 may be switched to half of Vin by the switched-capacitor operation. Then, with the help of the boost switch Q7 and the output switches Q5 or Q6, the system performs a boost conversion from one-half of Vin.

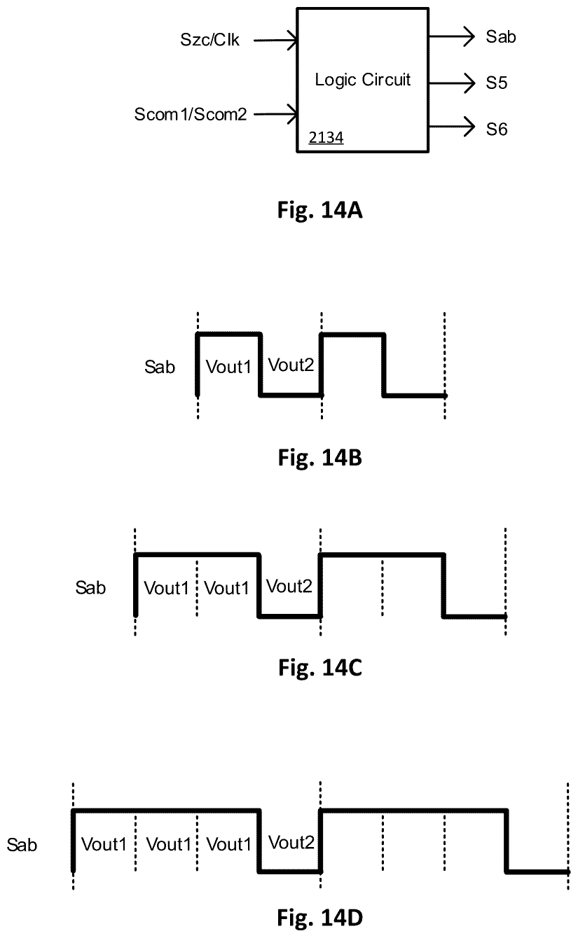

FIG. 14A is a schematic diagram illustrating a logic circuit according to an embodiment of the present invention. FIG. 14B-14D show waveform diagrams of the time-division switching control signal Sab in normal mode and skip mode. As shown in FIG. 14A, the logic circuit 2134 of the control circuit 213 is configured to generate the time-division switching control signal Sab, the first time-division signal S5, and the second time-division signal S6 based on the error amplification signals Scom1 and Scom2, and either the clock signal Clk or the zero current signal Szc. The signals Sab, S5, and S6 are triggered by Clk or Szc, and S5 and S6 are complementary, while Sab is synchronized with S5. Compared to the embodiment in FIG. 8, the logic circuit 2134 in FIG. 14A additionally uses the voltage difference between Scom1 and Scom2 to determine whether the converter enters a skip mode. In skip mode, the difference in the number of first and second inductance periods within a unit cycle Tsw is positively correlated with the difference between Iout1 and Iout2. In one embodiment, particularly under BCM and DCM, the voltage difference between Scom1 and Scom2 is directly proportional to the output current difference.

FIG. 14B illustrates a waveform of the time-division switching control signal Sab when the converter operates in normal mode. In this mode, Sab periodically alternates between high and low logic levels between the first output (Vout1) and the second output (Vout2), producing continuous and stable output waveforms that meet the system and load demands. The waveform shown in FIG. 14B demonstrates this regular high-low alternation within each unit cycle Tsw.

In one embodiment, when both output loads corresponding to Vout1/Iout1 and Vout2/Iout2 are not light and the difference between them is smaller than a threshold (e.g., when the difference between Scom1 and Scom2 is below a preset threshold), the logic circuit 2134 periodically alternates enabling S5 and S6. As a result, the converter operates in normal mode. For example, as in the embodiment of FIG. 10, this corresponds to two consecutive first inductance periods followed by two consecutive second inductance periods, repeating cyclically.

FIG. 14C illustrates a waveform of the signal Sab when the converter operates in one type of skip mode. FIG. 14D illustrates another type of skip mode. For instance, if the voltage difference between Scom1 and Scom2 exceeds a first threshold, the logic circuit 2134 activates skip mode. In the example shown in FIG. 14C, the signal Sab skips one high-level pulse of S6 in each unit cycle Tsw. In one embodiment, this means skipping two second inductance periods per cycle and repeating four first inductance periods followed by two second inductance periods.

When the difference between Scom1 and Scom2 continues to grow and stays above a second threshold (higher than the first threshold) for a preset duration, the logic circuit 2134 dynamically adjusts the high-low timing ratio of Sab based on the voltage difference. Specifically, as the difference increases, the duration or proportion of the high level in Sab increases, and the low level decreases accordingly. FIG. 14D shows this case, where two S6 high-level pulses are skipped in each unit cycle Tsw. For example, this corresponds to skipping four second inductance periods and repeating six first inductance periods followed by two second inductance periods.

This adjustment mechanism is referred to as the skip mode. Its purpose is to reduce the number of switching events under light-load conditions at one of the output ends by intentionally skipping a portion of the switching cycles. This helps to reduce energy loss and electromagnetic interference (EMI) caused by frequent switching, while still maintaining basic regulation of the output voltage.

Of course, when both the first output load and the second output load are under light-load conditions, the logic circuit 2134 may also skip at least one high-level pulse of the first time-division signal S5 and at least one high-level pulse of the second time-division signal S6 in each unit cycle Tsw.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, a unit cycle Tsw may also include a combination of a single first inductance period and a single second inductance period in sequence. In other words, one first inductance period and one second inductance period may alternately repeat. As long as capacitor charge balance can be achieved, such configuration is acceptable. For another example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A hybrid switching converter with a single inductor and multiple outputs, configured to convert an input voltage to a first output voltage and a second output voltage, the hybrid switching converter comprising:
a sub-switching converter configured to convert the input voltage to an intermediate voltage;
a first output switch configured to turn ON during a first inductance period to convert the intermediate voltage to the first output voltage based on a first time-division signal; and
a second output switch configured to turn ON during a second inductance period to convert the intermediate voltage to the second output voltage based on a second time-division signal;
wherein the sub-switching converter comprises:
a switched capacitor voltage divider circuit configured to perform a switched-capacitor operation to convert a first voltage to a first set of divided voltages with two different voltage levels by controlling a plurality of switches during the first inductance period based on a first set of pulse-width modulation (PWM) signals, and perform a switched-capacitor operation to convert the first voltage to a second set of divided voltages with two different voltage levels by controlling the plurality of switches during the second inductance period based on a second set of PWM signals;
an inductor having a first terminal coupled to the switched capacitor voltage divider circuit and a second terminal coupled to a second voltage;
wherein, during the first inductance period, the first terminal of the inductor is switched between the two voltage levels of the first set of divided voltages based on the first set of PWM signals;
wherein, during the second inductance period, the first terminal of the inductor is switched between the two voltage levels of the second set of divided voltages based on the second set of PWM signals; and
a control circuit configured to generate the first set of PWM signals, the second set of PWM signals, the first time-division signal, and the second time-division signal, to time-divisionally control the plurality of switches, the first output switch, and the second output switch, such that the same inductor is periodically magnetized and demagnetized during the first and second inductance periods to perform power conversion between the first voltage and the second voltage, and to correspondingly generate the first output voltage and the second output voltage during the first and second inductance periods, respectively;
wherein the first voltage and the second voltage respectively correspond to one of the input voltage and the intermediate voltage;
wherein the control circuit is further configured to regulate the first output voltage to a first target voltage based on a first feedback signal related to the first output voltage during the first inductance period, and regulate the second output voltage to a second target voltage based on a second feedback signal related to the second output voltage during the second inductance period;
wherein the hybrid switching converter with a single inductor and multiple outputs operates in a boundary conduction mode (BCM) or a discontinuous conduction mode (DCM) during the first and second inductance periods.

2. The hybrid switching converter with a single inductor and multiple outputs of claim 1, wherein any two consecutive first inductance periods achieve a capacitor balancing state, and any two consecutive second inductance periods achieve a capacitor balancing state.

3. The hybrid switching converter with a single inductor and multiple outputs of claim 1, wherein the control circuit comprises:
a first error amplifier configured to amplify a difference between the first output voltage feedback signal and a first reference signal to generate a first error amplification signal;
a second error amplifier configured to amplify a difference between the second output voltage feedback signal and a second reference signal to generate a second error amplification signal; and
a modulation circuit configured to generate the first set of PWM signals based on the first error amplification signal during the first inductance period, and to generate the second set of PWM signals based on the second error amplification signal during the second inductance period.

4. The hybrid switching converter with a single inductor and multiple outputs of claim 3, wherein the control circuit further includes a current sensing circuit configured to sense an inductor current flowing through the inductor and generate an inductor current signal, and the modulation circuit further generates the first and second sets of PWM signals based on the inductor current signal.

5. The hybrid switching converter with a single inductor and multiple outputs of claim 4, wherein the current sensing circuit further generates a zero current signal when the inductor current reaches zero current;
wherein the control circuit further comprises a logic circuit configured to generate the first and second time-division signals based on the zero current signal.

6. The hybrid switching converter with a single inductor and multiple outputs of claim 3, wherein the control circuit further comprises a logic circuit configured to generate the first time-division signal and the second time-division signal based on a clock signal.

7. The hybrid switching converter with a single inductor and multiple outputs of claim 3, wherein the control circuit further comprises a logic circuit configured to generate a time-division switching control signal, the first time-division signal, and the second time-division signal based on the first error amplification signal, the second error amplification signal, and a clock signal or a zero current signal;
wherein the time-division switching control signal, the first time-division signal, and the second time-division signal are all triggered by the clock signal or the zero current signal, and the first time-division signal and the second time-division signal are complementary to each other, and the time-division switching control signal is synchronized with the first time-division signal;
wherein the logic circuit is further configured to determine whether the hybrid switching converter with a single inductor and multiple outputs enters a skip mode based on a difference between a first output current and a second output current;
wherein in the skip mode, a difference between the number of first inductance periods and the number of second inductance periods in a unit cycle is positively correlated with the difference between the first and second output currents.

8. The hybrid switching converter with a single inductor and multiple outputs of claim 4, wherein the current sensing circuit comprises a sensing resistor and a sensing capacitor, wherein the sensing resistor and the sensing capacitor are connected in series and coupled to the inductor, and the inductor current is sensed by a voltage across the sensing capacitor to generate the inductor current signal, and a time constant of the sensing resistor and the sensing capacitor matches a time constant of the inductor and a DC resistance of the inductor.

9. The hybrid switching converter with a single inductor and multiple outputs of claim 1, wherein power conversion between the first voltage and the second voltage is a boost conversion or a buck conversion.

10. The hybrid switching converter with a single inductor and multiple outputs of claim 1, wherein when the switched capacitor voltage divider circuit and the inductor are configured in a buck topology, the sub-switching converter further comprises a boost switch coupled between a second terminal of the inductor and a reference potential, such that the hybrid switching converter selectively operates in a boost conversion or a buck conversion according to the first target voltage or the second target voltage.

11. The hybrid switching converter with a single inductor and multiple outputs of claim 1, wherein the first set of PWM signals determines a duty ratio for switching a first terminal of the inductor between the two voltage levels of the first set of divided voltages, and the second set of PWM signals determines a duty ratio for switching the first terminal of the inductor between the two voltage levels of the second set of divided voltages.

12. The hybrid switching converter with a single inductor and multiple outputs of claim 5, wherein a first starting point of a first ramp signal is triggered at the end of two consecutive first inductance periods, and another first starting point of the first ramp signal is triggered at the end of two consecutive second inductance periods;
wherein a second starting point of a second ramp signal is triggered at the end of the first one of the two consecutive first inductance periods, and another second starting point of the second ramp signal is triggered at the end of the first one of the two consecutive second inductance periods;
wherein the modulation circuit compares the first ramp signal and the second ramp signal with the first error amplification signal during the first inductance period to generate the first set of PWM signals;
wherein the modulation circuit compares the first ramp signal and the second ramp signal with the second error amplification signal during the second inductance period to generate the second set of PWM signals;
wherein the two consecutive first inductance periods and the two consecutive second inductance periods are arranged alternately and repeat periodically in sequence.

13. A control method for a hybrid switching converter with a single inductor and multiple outputs, comprising:
converting an input voltage to an intermediate voltage;
turning ON a first output switch during a first inductance period to output the intermediate voltage as a first output voltage based on a first time-division signal; and
turning ON a second output switch during a second inductance period to output the intermediate voltage as a second output voltage based on a second time-division signal;
wherein the step of converting the input voltage to the intermediate voltage includes:
during the first inductance period, controlling a plurality of switches based on a first set of pulse-width modulation (PWM) signals to perform a switched-capacitor operation and convert a first voltage to a first set of divided voltages with two different voltage levels; and
during the second inductance period, controlling the plurality of switches based on a second set of PWM signals to perform a switched-capacitor operation and convert the first voltage to a second set of divided voltages with two different voltage levels;
switching a first terminal of an inductor between the two voltage levels of the first set of divided voltages based on the first set of PWM signals during the first inductance period;
switching the first terminal of the inductor between the two voltage levels of the second set of divided voltages based on the second set of PWM signals during the second inductance period;
time-divisionally controlling the plurality of switches using the first set of PWM signal and the second set of PWM signal, such that the same inductor is periodically magnetized and demagnetized during the first inductance period and the second inductance period to perform power conversion between the first voltage and the second voltage;
wherein the first voltage and the second voltage respectively correspond to one of the input voltage and the intermediate voltage;
time-divisionally controlling the first output switch and the second output switch using the first time-division signal and the second time-division signal to correspondingly generate the first output voltage and the second output voltage during the first inductance period and the second inductance period; and
adjusting the first output voltage to a first target voltage based on a first feedback signal related to the first output voltage during the first inductance period, and adjusting the second output voltage to a second target voltage based on a second feedback signal related to the second output voltage during the second inductance period;
wherein the hybrid switching converter with a single inductor and multiple outputs operates in a boundary conduction mode (BCM) or a discontinuous conduction mode (DCM) during the first and second inductance periods.

14. The control method of claim 13, wherein any two consecutive first inductance periods achieve a capacitor balancing state, and any two consecutive second inductance periods achieve a capacitor balancing state.

15. The control method of claim 13, wherein the step of time-divisionally controlling the plurality of switches, the first output switch, and the second output switch to periodically magnetize and demagnetize the same inductor during the first and second inductance periods to perform power conversion between the first and second voltages includes:
amplifying a difference between the first output voltage feedback signal and a first reference signal to generate a first error amplification signal;
amplifying a difference between the second output voltage feedback signal and a second reference signal to generate a second error amplification signal; and
generating the first set of PWM signals based on the first error amplification signal during the first inductance period, and generating the second set of PWM signals based on the second error amplification signal during the second inductance period.

16. The control method of claim 15, wherein the step of time-divisionally controlling the plurality of switches, the first output switch, and the second output switch to periodically magnetize and demagnetize the same inductor during the first and second inductance periods to perform power conversion between the first and second voltages further includes:
sensing an inductor current to generate an inductor current signal, and
further generating the first and second sets of PWM signals based on the inductor current signal.

17. The control method of claim 16, wherein the step of time-divisionally controlling the plurality of switches, the first output switch, and the second output switch to periodically magnetize and demagnetize the same inductor during the first and second inductance periods to perform power conversion between the first and second voltages further includes:
generating a zero current signal when the inductor current reaches zero based on the inductor current signal; and
generating the first and second time-division signals based on the zero current signal.

18. The control method of claim 15, wherein the step of time-divisionally controlling the plurality of switches, the first output switch, and the second output switch to periodically magnetize and demagnetize the same inductor during the first and second inductance periods to perform power conversion between the first and second voltages further includes:
generating the first and second time-division signals based on a clock signal.

19. The control method of claim 15, wherein the step further comprises:
generating a time-division switching control signal, the first time-division signal, and the second time-division signal based on the first error amplification signal and the second error amplification signal and a clock signal or a zero current signal; and
determining whether the hybrid switching converter enters a skip mode based on a voltage difference between the first error amplification signal and the second error amplification signal;
wherein the time-division switching control signal and the first time-division signal and the second time-division signal are triggered by the clock signal or the zero current signal, and the first time-division signal and the second time-division signal are complementary;
wherein in the skip mode, a difference between the number of first inductance periods and the number of second inductance periods in a unit cycle is positively correlated with a difference between a first output current and a second output current.

20. The control method of claim 16, wherein the step of sensing the inductor current to generate the inductor current signal includes:
providing a sensing resistor and a sensing capacitor, wherein the sensing resistor and the sensing capacitor are connected in series and coupled to the inductor, and the inductor current is sensed based on a voltage across the sensing capacitor to generate the inductor current signal;
wherein a time constant of the sensing resistor and the sensing capacitor matches a time constant of the inductor and a DC resistance of the inductor.

21. The control method of claim 13, wherein power conversion between the first voltage and the second voltage is a boost conversion or a buck conversion.

22. The control method of claim 13, wherein the first set of PWM signals determines a duty ratio for switching a first terminal of the inductor between the two voltage levels of the first set of divided voltages, and the second set of PWM signals determines a duty ratio for switching the first terminal of the inductor between the two voltage levels of the second set of divided voltages.

23. The control method of claim 17, wherein a first starting point of a first ramp signal is triggered at the end of two consecutive first inductance periods, and another first starting point of the first ramp signal is triggered at the end of two consecutive second inductance periods;
wherein a second starting point of a second ramp signal is triggered at the end of a first one of two consecutive first inductance periods, and another second starting point of the second ramp signal is triggered at the end of a first one of two consecutive second inductance periods;
wherein, during the first inductance period, the first ramp signal is compared with the first error amplification signal, and the second ramp signal is compared with the first error amplification signal, to generate the first set of PWM signals;
wherein, during the second inductance period, the first ramp signal is compared with the second error amplification signal and the second ramp signal is compared with the second error amplification signal, to generate the second set of PWM signals;
wherein the two consecutive first inductance periods and the two consecutive second inductance periods are alternately arranged and repeated sequentially and periodically.
